(19) United States
(12) Patent Application Publication
(10) Pub. No.: US 2018/0115434 A1
(43) Pub. Date: Apr. 26, 2018

(54) SPECTRAL EXTENSION IN A CABLE NETWORK

(71) Applicant: Futurewei Technologies, Inc., Plano, TX (US)

(72) Inventors: Xiaolong Zhang, Santa Clara, CA (US); Li Zhang, Santa Clara, CA (US); Tao Ouyang, Santa Clara, CA (US); James Jeng Chen, Corona, CA (US)

(21) Appl. No.: 15/788,515

(22) Filed: Oct. 19, 2017

Related U.S. Application Data
(60) Provisional application No. 62/410,986, filed on Oct. 21, 2016.
(60) Provisional application No. 62/410,992, filed on Oct. 21, 2016.

(51) Int. Cl. H04L 12/28; H04L 5/14

(52) U.S. Cl. CPC H04L 12/2801; H04Q 2213/13199; H04L 5/14

(57) ABSTRACT

A system for cable network communications is provided, comprising a cable modem termination system (CMTS), a trunk cable coupled to the CMTS, cable modems (CMs) divided into at least a low frequency CM group and a high frequency CM group positioned between the CMTS and the low frequency CM group, one or more second taps attached to the trunk cable, with corresponding second drop cables coupled to one or more corresponding CMs of the low frequency CM group, and a first duplexer tap attached to the trunk cable between the CMTS and the one or more second taps, with a corresponding first drop cable coupled to a CM of the high frequency CM group. The first duplexer tap receives an input signal and provides a low frequency signal to the low frequency CM group and a high frequency signal to the high frequency CM group.

### CROSS-REFERENCE TO RELATED APPLICATION

This application claims priority to U.S. Provisional Application Ser. No. 62/410,986, filed Oct. 21, 2016, and to U.S. Provisional Application Ser. No. 62/410,992, filed Oct. 21, 2016, both of which are incorporated herein by reference.

### TECHNICAL FIELD

The present disclosure relates to cable modem communication, and in particular to spectrum extension in a cable network.

### BACKGROUND

Cable modems receive signals from a server, such as video signals and other data, on a downstream portion of a frequency spectrum. The server is typically called a cable modem termination system (CMTS), which is coupled to cable modems via a hybrid fiber and coaxial cable (HFC) network. The downstream portion of the frequency spectrum typically ranges from a lower frequency of about 108 to about 258 MHz up to an upper frequency of about 1218 to about 1794 MHz. Cable modems also provide data back to the server on an upstream portion of the frequency spectrum. The division of the spectrum is referred to as frequency division duplex (FDD), which utilizes different portions of the frequency spectrum for upstream and downstream communications, which when used simultaneously, is referred to as full duplex. The upstream portion has a range that is typically 5 MHz to 85 or 204 MHz, depending on the downstream portion of the spectrum being used. The upstream portion and downstream portion of the spectrum may be simultaneously used for downstream and upstream transmissions.

In full duplex cable modem systems, there can be interference between different modems. To minimize the interference, constraints have been placed on the cable modems, such as a modem receiving on a channel cannot transmit on that channel, but other sufficiently radio frequency (RF) isolated modems may transmit on that channel. Intelligent scheduling by the CMTS may also be utilized to minimize such interference. Still further, cable modems may be assigned to various transmission groups to minimize interference.

Protocols for implementing communications in cable systems are described in a DOCSIS® family of specifications developed by Cable Television Laboratories (CableLabs). The family of specifications defines a fifth generation of high-speed data-over-cable systems, commonly referred to as the DOCSIS 3.1 specifications.

### SUMMARY

A system for cable network communications is provided, the system comprising a cable modem termination system (CMTS), a trunk cable coupled to the CMTS, a plurality of cable modems (CMs) divided into at least a low frequency CM group and a high frequency CM group, with the high frequency CM group positioned between the CMTS and the low frequency CM group, one or more second taps attached to the trunk cable, with corresponding second drop cables coupled to the one or more second taps and further coupled to one or more corresponding CMs of the low frequency CM group, and a first duplexer tap attached to the trunk cable between the CMTS and the one or more second taps, with a corresponding first drop cable coupled to the first duplexer tap and further coupled to a CM of the high frequency CM group, with the first duplexer tap receiving an input signal from the CMTS and providing a low frequency signal of the input signal to the low frequency CM group and providing a high frequency signal of the input signal to the high frequency CM group.

In some embodiments of the system, the high frequency signal comprises an about 2.2 Gigahertz (GHz) to about 3 GHz frequency band and the low frequency signal comprises an about 1 Megahertz (MHz) to about 2.2 GHz frequency band.

In some embodiments of the system, the high frequency signal comprises an about 2.0 GHz to about 3 GHz frequency band and the low frequency signal comprises an about 1 Megahertz (MHz) to about 2 GHz frequency band.

In some embodiments of the system, the system further comprises one or more second duplexer taps attached to the trunk cable between the first duplexer tap and the one or more second taps and forming a medium frequency CM group, with corresponding second duplexer drop cables coupled to the one or more second duplexer taps and further coupled to one or more corresponding medium frequency CMs of the medium frequency CM group.

In some embodiments of the system, the high frequency signal comprises an about 2.2 Gigahertz (GHz) to about 3 GHz frequency band, the medium frequency signal comprises an about 1 Gigahertz (GHz) to about 2.2 GHz frequency band, and the low frequency signal comprises an about 100 Megahertz (MHz) to about 1 GHz frequency band.

In some embodiments of the system, the high frequency signal comprises an about 2.0 GHz to about 3 GHz frequency band, the medium frequency signal comprises an about 1 Gigahertz (GHz) to about 2 GHz frequency band, and the low frequency signal comprises an about 1 Megahertz (MHz) to about 1 GHz frequency band.
In some embodiments of the system, the duplexer tap comprises two duplexer components.
In some embodiments of the system, the duplexer tap comprises a first duplexer receiving the input signal of the duplexer tap and providing a low frequency signal and a high frequency signal from the input signal, a second duplexer receiving the high frequency signal from the first duplexer and receiving a branch signal from a tap and outputting the high frequency signal on a branch port of the duplexer tap, and the tap receiving the low frequency signal from the first duplexer and outputting the low frequency signal on an output port of the duplexer tap.

In some embodiments of the system, the tap further outputs the branch signal on a branch port of the tap.

In some embodiments of the system, the duplexer tap comprises a first duplexer coupled to an input port of the duplexer tap and receiving the input signal from the input port, with the first duplexer providing a low frequency signal on a low frequency port of the first duplexer and providing a high frequency signal on a high frequency port of the first duplexer, a second duplexer having a high frequency port coupled to the high frequency port of the first duplexer and having a low frequency port coupled to a tap, with the second duplexer combining a high frequency signal received from the first duplexer and a branch signal received from the tap and outputting the high frequency signal on a branch port and on a branch port of the duplexer tap, and the tap coupled to the low frequency port of the first duplexer, coupled to the low frequency port of the second duplexer, and coupled to the output port of the duplexer tap, with the tap outputting the low frequency signal on the output port of the duplexer tap.

A method for cable network communications is provided, the method comprising a tap receiving an input signal, with the tap located on a trunk cable of a cable network, the tap dividing the input signal into at least a high frequency signal and a low frequency signal and providing the high frequency signal to a high frequency cable modem (CM) group, wherein the high frequency signal is transmitted over a drop cable from the tap to a CM of the high frequency CM group, and the tap providing the low frequency signal to a low frequency CM group, wherein the low frequency signal is transmitted over one or more drop cables coupled to one or more corresponding CMs of the low frequency CM group and wherein the low frequency CM group is downstream of the high frequency CM group.

In some embodiments of the method, the high frequency signal comprises an about 2.2 Gigahertz (GHz) to about 3 GHz frequency band and the low frequency signal comprises an about 1 Megahertz (MHz) to about 2.2 GHz frequency band.

In some embodiments of the method, the high frequency signal comprises an about 2.0 GHz to about 3 GHz frequency band and the low frequency signal comprises an about 1 Megahertz (MHz) to about 2 GHz frequency band.

In some embodiments of the method, the method further comprises a downstream tap located on the trunk cable receiving the low frequency signal from the tap, the downstream tap dividing the low frequency signal into a medium frequency signal and a lower frequency signal and providing the medium frequency signal to a medium frequency CM group, and the downstream tap providing the lower frequency signal to the low frequency CM group.

In some embodiments of the method, the high frequency signal comprises an about 2.2 Gigahertz (GHz) to about 3 GHz frequency band, the medium frequency signal comprises an about 1 Gigahertz (GHz) to about 2.2 GHz frequency band, and the low frequency signal comprises an about 100 Megahertz (MHz) to about 1 GHz frequency band.

In some embodiments of the method, the high frequency signal comprises an about 2.0 GHz to about 3 GHz frequency band, the medium frequency signal comprises an about 1 Gigahertz (GHz) to about 2 GHz frequency band, and the low frequency signal comprises an about 1 Megahertz (MHz) to about 1 GHz frequency band.

In some embodiments of the method, the method further comprises receiving the input signal of the duplexer tap at a first duplexer and the first duplexer providing a low frequency signal and a high frequency signal from the input signal, receiving the high frequency signal from the first duplexer at a second duplexer and the second duplexer receiving a branch signal from a tap and outputting the high frequency signal on a branch port of the duplexer tap, and receiving the low frequency signal from the first duplexer at a tap and the tap outputting the low frequency signal on an output port of the duplexer tap.

In some embodiments of the method, the method further comprises outputting the branch signal on a branch port of the tap.

This Summary is an overview of some of the teachings of the present application and not intended to be an exclusive or exhaustive treatment of the present subject matter. Further details about the present subject matter are found in the detailed description and appended claims The scope of the present invention is defined by the appended claims and their legal equivalents.

### BRIEF DESCRIPTION OF THE DRAWINGS

FIG. 1 is a circuit diagram illustrating a passive cable communications network.

FIG. 2 is a graph illustrating signal power loss for the network of FIG. 1.

FIG. 3 is a circuit diagram illustrating a cable communications network with 3 GHz extension, according to various embodiments.

FIG. 4 is a graph illustrating signal power loss for the network of FIG. 3, according to various embodiments.

FIG. 5 is a circuit diagram illustrating a cable communications network with a replacement tap, according to various embodiments.

FIG. 6 is a circuit diagram illustrating a cable communications network with a replacement duplexer tap, according to various embodiments.

FIG. 7 illustrates a duplexer tap for use in a cable communications network, according to various embodiments.

FIG. 8 is a diagram illustrating circuitry for implementing devices to perform methods according to an example embodiment.

FIG. 9A is a circuit diagram illustrating a tap for cable network communications.

FIG. 9B is a graph illustrating signal power loss for a tap in a cable network.

FIG. 10 is a circuit diagram illustrating a cable communications network with 3 GHz extension, according to various embodiments.

FIG. 11 is a circuit diagram illustrating a cable communications network with a replacement duplexer tap, according to various embodiments.

FIG. 12A illustrates a one-way duplexer tap with two duplexers for use in a cable communications network, according to various embodiments.

FIG. 12B illustrates an N-way duplexer tap with two duplexers for use in a cable communications network, according to various embodiments.

FIG. 13A illustrates a one-way duplexer tap with two duplexers for use in a cable communications network, according to various embodiments.

FIG. 13B illustrates an N-way duplexer tap with two duplexers for use in a cable communications network, according to various embodiments.

FIG. 14 is a graph illustrating signal power loss for the duplexer tap of FIG. 12A, according to various embodiments.

FIG. 15 is a graph illustrating signal power loss for the duplexer tap of FIG. 13A, according to various embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The present disclosure relates to cable modem communication, and in particular to applying multiple spectral domains in a DOCSIS® cable network with 3 GHz spectrum expansion and using a tap to support 3 GHz spectrum extension in a DOCSIS® cable network.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

Current protocols for implementing communications in cable systems are described in a DOCSIS® family of specifications developed by Cable Television Laboratories (CableLabs). The family of specifications defines a fifth generation of high-speed data-over-cable systems, commonly referred to as the DOCSIS 3.1 specifications.

Cable modems (CMs) receive signals from a server, such as video signals and other data on a downstream portion of a frequency spectrum. The server is typically called a cable modem termination system (CMTS), which is coupled to the cable modems via a hybrid fiber and coaxial (or coax) cable (HFC) network.

### Multiple Spectral Domains in a Cable Network

In order to compete with fiber optic systems such as fiber to the home (FTTH), cable networking system operators may skip N+3 and N+1 and deploy the fiber directly to N+0, where N+0 refers to a node-plus-zero architecture, in which there are no amplifiers required between a node and a subscriber household. Presently, the available cable spectrum is 1.2 GHz and targets the provision of 6 Gbps in upstream and 10 Gbps in downstream per service group in short term. In the near future (5-10 years), the target is about 8 Gbps in upstream and 24 Gbps in downstream transmission speed. For N+0 network communications, coax cable will be kept as long as possible in the last 200-300 meters from a target. Thus, it is desirable for a coax cable to support 3 GHz communications and provide 25 Gbps in downstream transmission speed.

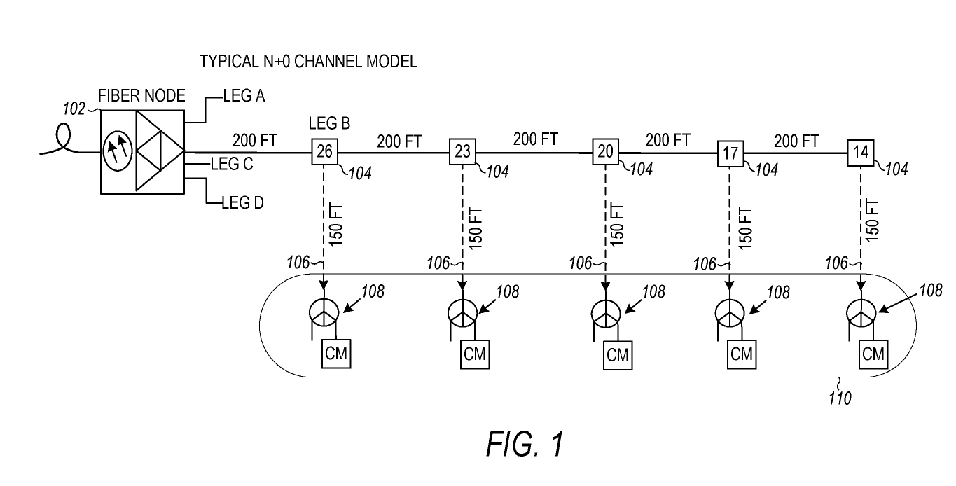

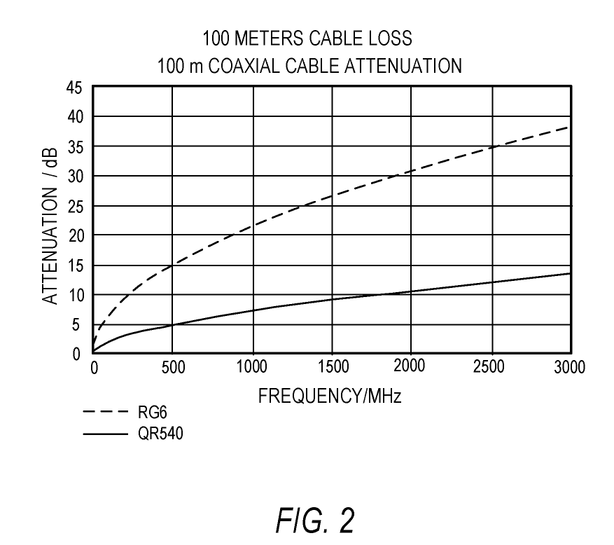

FIG. 1 is a circuit diagram illustrating a passive cable communications network. A typical N+0 coax network includes a fiber node 102 having 4-5 taps 104 with 200 feet of trunk cable spacing, and the trunk cable type is usually QR540 hardline. A drop cable 106 connected to the taps 104 is typically 150 feet length and the type is typically RG6. As shown in FIG. 2, the 200 foot trunk cable loss at 3 GHz for the network of FIG. 1 is about 7.8 decibels (dB), and the 150 foot drop cable loss at 3 GHz is about 19 dB, using current passive components such as 1.2 GHz type taps and splitters. As shown in FIG. 1, the current system uses a single spectral domain 110 for all CMs 108 in the network.

Major issues for cable network 3 GHz extension include radio frequency (RF) signal power loss and tap and splitter replacement. Regarding RF signal power loss, the current fastest CM includes a 1000 foot trunk and 150 foot drop from the CMTS, which results in a maximum signal loss at 3 GHz of more than 80 dB, as shown in FIG. 2. However, the acceptable cable network loss is about 50-60 dB based on cable components currently in use. Regarding tap and splitter replacement, in order to support 3 GHz network communications, cable operators need to replace all the taps and splitters to 3 GHz to support the required 50-60 dB network loss. This would be a costly and extensive upgrade for cable operators.

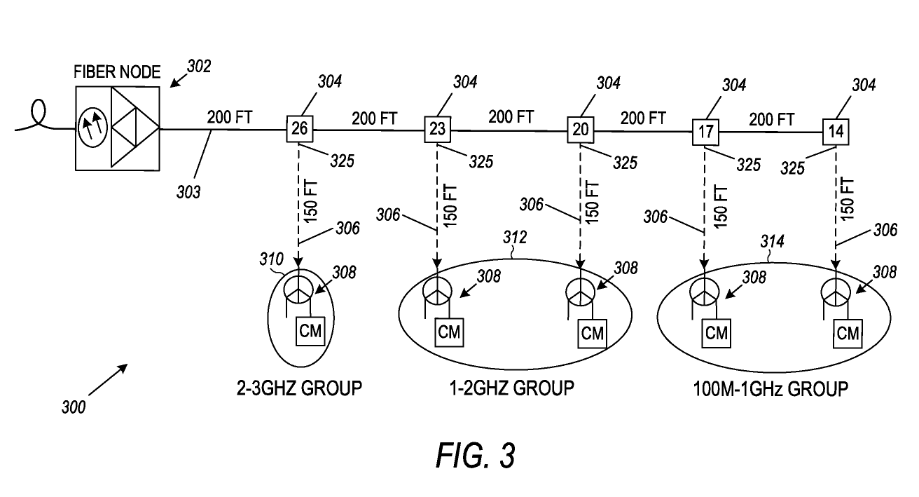

FIG. 3 shows a cable network 300 according to an embodiment. The cable network 300 includes a trunk cable 303 coupled to a fiber node 302, such as a CMTS 302. The trunk cable 303 comprises a coaxial cable. Taps 304 are attached to the trunk cable 303 at spaced-apart distances. The distances shown in the figure are merely examples, and distances between taps 304 may vary. In addition, such distances may not necessary be uniform or similar. It should be understood that a tap 304 may be clamped onto the trunk cable 303, or may join cable segments together to form the trunk cable 303.

Each tap 304 receives signals in the trunk cable 303. Each tap further includes a branch port 325 coupled to a drop cable 306 that couples the tap 304 to a corresponding CM 308. Signals transmitted into the trunk cable 303 by the CMTS 302 are received in the taps 304, and the signals are typically transferred to the CMs 308 by the drop cables 306. In addition, signals transmitted by the CMs 308 travel through drop cables 306 into the taps 304, then into the trunk cable 303 to the CMTS 302.

The taps 304 are coaxial taps and provide tap outputs for the CMs 308 as described below. The taps 304 are passive devices and do not supply power to the signal or receive electrical power as an input. The taps 304 may connect to any number of CMs 308. The taps 304 typically block the AC power from the coaxial cable line 120. The taps 304 are typically located at individual houses, at the ends of streets, or at other similar locations, wherein the taps 304 distribute the signal received from the CMTS 302.

The tap 304 typically has a tap loss characteristic wherein the signal at the branch port 325 of the tap 304 is attenuated with respect to the signal at the input port of the tap 304. In some examples, the tap loss characteristic between the branch port 325 and the output port can comprise an about 23 decibel (dB) or 26 dB tap loss. The taps 304 in the figure have tap loss values from right to left in the figure of 26 dB, 23 dB, 20 dB, 17 dB, and 14 dB.

The tap 304 can typically also have an isolation loss characteristic wherein the signal at the branch port 325 of the tap 304 is attenuated with respect to the signal at the output port of the tap 304. In some examples, the isolation loss characteristic between the branch port 325 and the output port can comprise an about 35 dB loss.

In some embodiments, the taps affix to the cable and the trunk cable 303 comprises a single span. In other embodiments, the trunk cable 303 comprises a series of segments.

In the embodiment shown, the high frequency CM group includes only a single CM. Alternatively, the high frequency CM group can include multiple CMs.

The present subject matter solves the problem by grouping CMs 308 based on the distance to CMTS 302, and assigning different spectrum ranges to the groups. In one example shown in FIG. 3, a high spectrum band (2-3 GHz) is assigned to the near-distance CMs 310, a middle spectrum band is assigned to CMs in the mid-distance 312, and a low spectrum band is assigned to the far-distance CMs 314. Various numbers of CMs can be included in each CM group, and can differ from the example shown in the figure.

The system of the present subject matter balances the cable signal loss slope by assigning a short path to high band communications and a long path to low band communications. For example, 3 GHz signals can only pass in a 200 foot trunk with a 150 foot drop cable from the trunk, resulting in a signal loss of about 60 dB. In this example, the 1 GHz signal passes through a 5×200 foot trunk with a 150 foot drop cable, resulting in a signal loss of approximately 50-60 dB. Thus, because only the near CM group operates at 3 GHz, the cable operators can only change the tap and splitter in the near CM path, and avoid changing any other downstream taps, saving money and time.

In some embodiments, the high frequency signal comprises an about 2.2 Gigahertz (GHz) to about 3 GHz frequency band and the low frequency signal comprises an about 1 Megahertz (MHz) to about 2.2 GHz frequency band. In other embodiments, the high frequency signal comprises an about 2.0 GHz to about 3 GHz frequency band and the low frequency signal comprises an about 1 Megahertz (MHz) to about 2 GHz frequency band.

In some embodiments, the system further comprises one or more second duplexer taps 304 attached to the trunk cable 303 between the first duplexer tap 304 and the one or more second taps 304 and forming a medium frequency CM group 312, with corresponding second duplexer drop cables 306 coupled to the one or more second duplexer taps 304 and further coupled to one or more corresponding medium frequency CMs 308 of the medium frequency CM group 312. In some embodiments, the high frequency signal comprises an about 2.2 Gigahertz (GHz) to about 3 GHz frequency band, the medium frequency signal comprises an about 1 Gigahertz (GHz) to about 2.2 GHz frequency band, and the low frequency signal comprises an about 100 Megahertz (MHz) to about 1 GHz frequency band. In other embodiments, the high frequency signal comprises an about 2.0 GHz to about 3 GHz frequency band, the medium frequency signal comprises an about 1 Gigahertz (GHz) to about 2 GHz frequency band, and the low frequency signal comprises an about 1 Megahertz (MHz) to about 1 GHz frequency band.

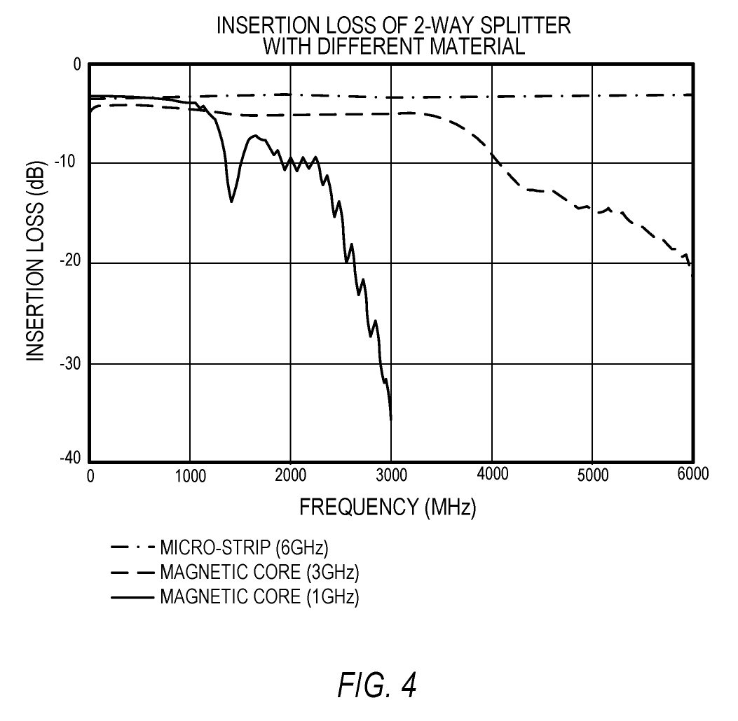

FIG. 4 is a graph illustrating signal power loss for the network of FIG. 3, according to various embodiments.

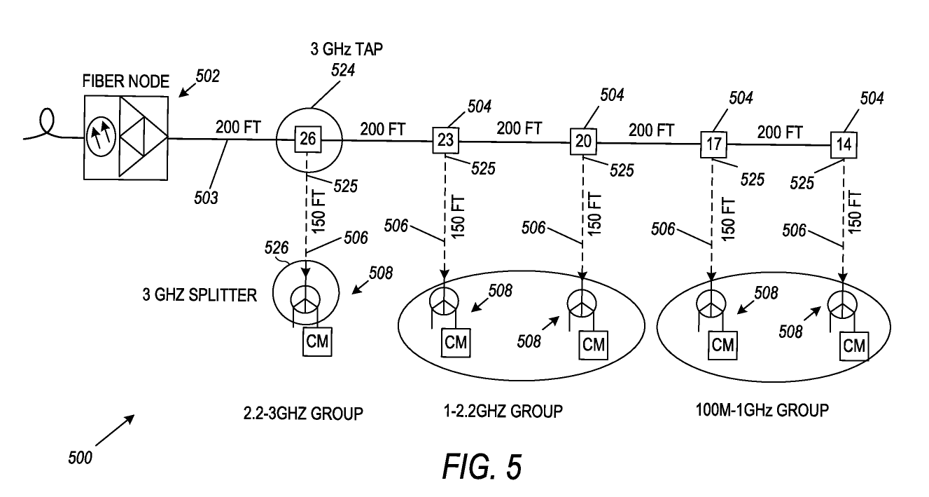

FIG. 5 is a circuit diagram illustrating a cable communications network with a replacement tap, according to various embodiments. The first tap (nearest the CMTS 502) is replaced with a 3 GHz tap 524 and the first splitter is replaced with a 3 GHz splitter 526, in this embodiment. The insert loss of a 1.2 GHz tap and splitter is less than 10 dB at 1.5˜2.2 GHz spectral range. Thus, it is possible to compensate for the additional loss by increasing CMTS transmitting power and not to replace the tap and splitter in the 1-2 GHz group. In addition, the present subject matter provides for moving 200 MHz spectral communications from the 2-3 GHz group to the 1-2 GHz group to balance the network capacity.

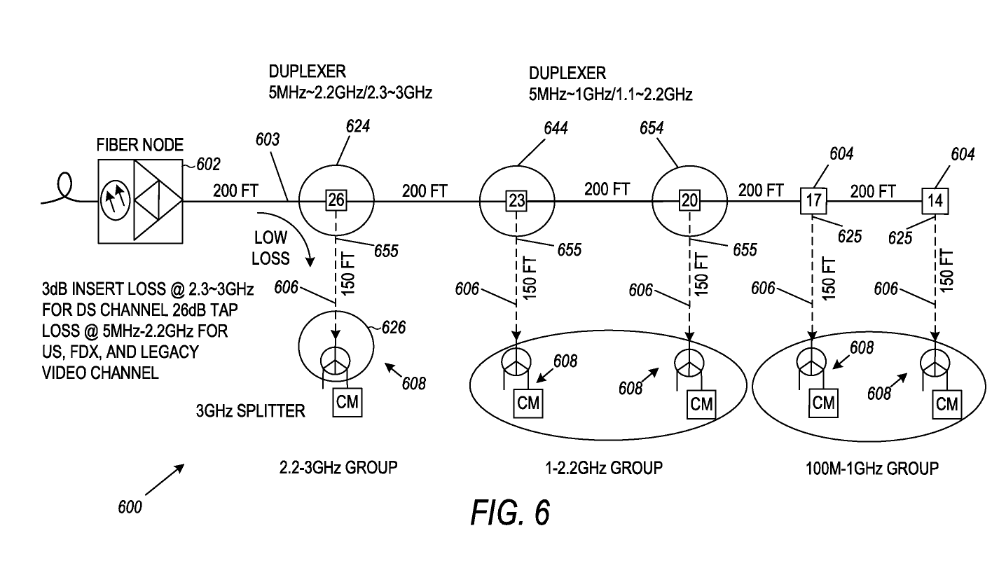

FIG. 6 is a circuit diagram illustrating a cable communications network with a replacement duplexer tap, according to various embodiments. In various embodiments, the trunk tap (or tap nearest the CMTS 602) is replaced with a duplexer tap 624 which passes the high spectral band signal to the CMs 626. This duplexer tap 624 (as described in copending application number 4368.147PRV) significantly reduces the tap loss in high frequency bands since it provides for no signal power branch loss and only 1-3 dB duplexer insert loss.

In order to support current upstream communications, video and full duplex communications (FDX) channels which usually locate at 5 MHz˜1.2 GHz in the 3 GHz CM group, the tap branches the low band signal with a 26 dB TAP to a 3 GHz drop cable, in various embodiments.

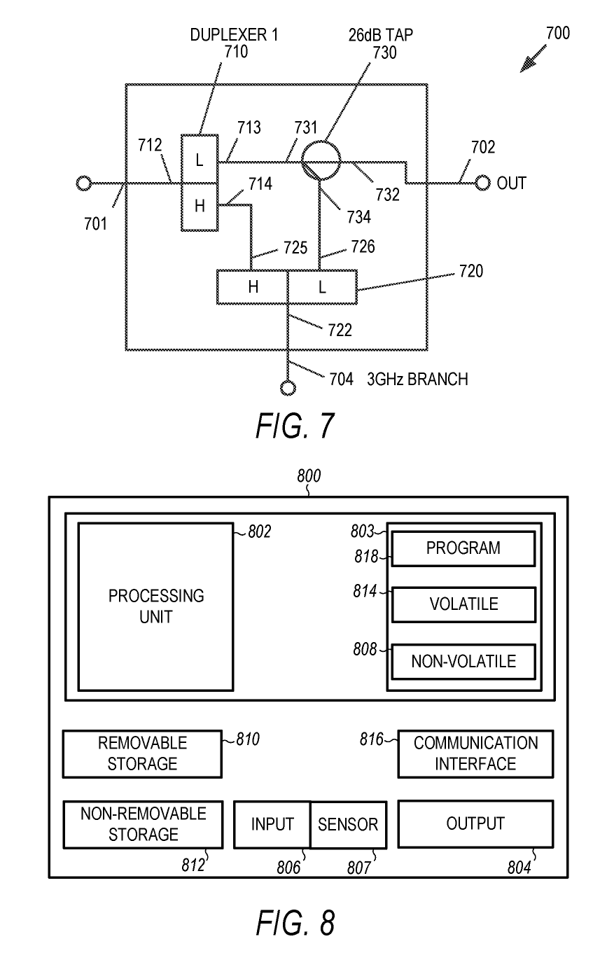

FIG. 7 shows a duplexer tap 700 according to an embodiment. The duplexer tap 700 in the embodiment shown includes an input port 701, an output port 702, and a branch port 704. The duplexer tap 700 in the embodiment shown further includes a first duplexer 710, a second duplexer 720, and a tap 730. A combination port 712 of the first duplexer 710 is coupled to the input port 701 of the duplexer tap 700. A combination port 722 of the second duplexer 720 is coupled to the branch port 704 of the duplexer tap 700. An output 732 of the tap 730 is coupled to the output port 702 of the duplexer tap 700. An input 731 of the tap 730 is coupled to a low frequency port 713 of the first duplexer 710. The high frequency output port 714 of the first duplexer 710 is coupled to the high frequency port 725 of the second duplexer 720. A low frequency port 726 of the second duplexer 720 is coupled to a branch port 734 of the tap 730.

Coaxial cable can be coupled to the input port 701, the output port 702, and the branch port 704 in some examples. A frequency division duplex (FDD) analog signal is received at the input port 701. The FDD analog signal is distributed to the output port 702 and the branch port 704 of the duplexer tap 700 based on frequency characteristics (or frequency bands) of the FDD analog signal. The FDD analog signal can comprise multiple signals at different frequency bands, as previously discussed.

A duplexer (such as the first duplexer 710 and the second duplexer 720) can receive a combined signal at the combined port and split the combined signal into low frequency signal at the low frequency port and into a high frequency signal at the high frequency port. The low frequency signal and the high frequency signal may be a single signal or may comprise multiple signal components. The duplexers may comprise a filter or filters that split the received signal into the low frequency and high frequency signal. The duplexers may comprise any suitable low pass filters, high pass filters, band pass filters, or other suitable frequency-selective components. Conversely, if the duplexer receives a low frequency signal at the low frequency port and receives the high frequency at the high frequency port, the duplexer can combine the low and high frequency signals to generate a combined signal at the combined port, including both the low frequency and high frequency signals or components. In example embodiments, the first duplexer 710 and the second duplexer 720 can comprise a duplexer available from Anatech Electronics of Garfield, N.J., USA. In example embodiments, the first duplexer 710 and the second duplexer 720 can comprise a duplexer available from Anixter Company of Glenview, Ill., USA. In example embodiments, the first duplexer 710 and the second duplexer 720 can comprise a duplexer available from Holland Electronics LLC of Ventura, Calif., USA.

The first duplexer 710 divides the signal received on the combined port 712 into low frequency (L) components or bands (i.e., a low frequency signal) at the low frequency port 713 and into high frequency (H) components or bands (i.e., a high frequency signal) at the high frequency port 714. Conversely, the second duplexer 720 receives the high frequency signal from the first duplexer 710 at the high frequency port 725 and receives a signal from the tap 730 at the low frequency port 726, outputting the combined signal at the combined port 722, to the branch port 704 of the duplexer tap 700.

Where a single duplexer tap 700 is used in a cable distribution network, the CMs of the cable distribution network can be grouped into a low frequency group and a high frequency group. Alternatively, where at least two duplexer taps 700 are used, the CMs of the cable distribution network can be grouped into a low frequency group, a middle frequency group, and a high frequency group, such as shown in FIGS. 3, 5-6, and 10-11.

In one example, a FDD analog signal is received at the input port 701 of the duplexer tap 700. The first duplexer 710 receives the FDD analog signal and divides it into a low frequency signal (at about 1 MHz to about 2.2 GHz in some examples) on the low frequency port 713 and a high frequency signal (at about 2.2-3 GHz in some examples) on the high frequency port 714. The low frequency signal from the first duplexer 710 is provided to the input port 731 of the tap 730. The tap 730 receives the low frequency signal (such as a signal of 1 MHz to 2.2 GHz, for example) and outputs the low frequency signal at the branch output 734 and at the output 632 of the tap 730. The high frequency signal from the first duplexer 710 is provided to the high frequency port 725 of the second duplexer 720, where it is combined with the low frequency signal received from the tap 730 at the low frequency port 726. The signals are combined and output at the combined port 722 of the second duplexer 720. As a result, the first duplexer 710 splits off a 2.3˜3 GHz spectrum portion and passes the 2.3˜3 GHz spectrum portion to the second duplexer 720. The tap 730 receives the low frequency signal and provides the low frequency signal to the output 732 of the tap 730. The second duplexer 720 combines the 2.3-3 GHz signal and the 5-2.2 GHz signal, with an approximately 26 dB tap loss, in various embodiments.

In some embodiments, the first duplexer 710 has an about 2 Gigahertz (GHz) cut-off frequency. In other embodiments, the first duplexer 710 has an about 2.2 Gigahertz (GHz) cut-off frequency.

In some embodiments, the duplexer tap 700 comprises two duplexer components.

In some embodiments, the duplexer tap 700 comprises the first duplexer 710 receiving the input signal of the duplexer tap 700 and providing the low frequency signal and the high frequency signal from the input signal. The duplexer tap 700 in this embodiment further comprises the second duplexer 720 receiving the high frequency signal from the first duplexer 710 and receiving the branch signal from the tap 730 and outputting the high frequency signal on the branch port 704 of the duplexer tap 700. The duplexer tap 700 in this embodiment further comprises the tap 730 receiving the low frequency signal from the first duplexer 710 and outputting the low frequency signal on the output port 702 of the duplexer tap 700. In some embodiments, the tap 730 further outputs the branch signal on the branch port 734 of the tap 730.

In some embodiments, the duplexer tap 700 comprises the first duplexer 710 coupled to the input port 701 of the duplexer tap 700 and receiving the input signal from the input port, with the first duplexer 710 providing the low frequency signal on the low frequency port 713 of the first duplexer 710 and providing the high frequency signal on the high frequency port 714 of the first duplexer 710. The duplexer tap 700 in this embodiment further comprises the second duplexer 720 having the high frequency port 725 coupled to the high frequency port 714 of the first duplexer 710 and having the low frequency port 726 coupled to the tap 730, with the second duplexer 720 combining the high frequency signal received from the first duplexer 710 and the branch signal received from the tap 730 and outputting substantially just the high frequency signal on the branch port 722 and therefore on the branch port 704 of the duplexer tap 700. The duplexer tap 700 in this embodiment further comprises the tap 730 coupled to the low frequency port 713 of the first duplexer 710, coupled to the low frequency port 726 of the second duplexer 720, and coupled to the output port 702 of the duplexer tap 700, with the tap 730 outputting the low frequency signal on the output port 702 of the duplexer tap 700.

As shown in FIG. 1, the current coax cable spectral range is 1.2 GHz with a single spectral domain, so it does not have multiple spectral domains to support 3 GHz, as provided by the present subject matter (for example in FIG. 3). Thus, the present subject matter provides for grouping CMs based on available spectral domains, i e multiple domains of spectral frequency can be divided and assigned to different groups of CMs connected in a cable link. A cable link is a point to multi-point link, such that a cable link can be shared by multiple CMs simultaneously for transmission or reception. According to various embodiments of the present subject matter, the CMs can be grouped to transmit or receive in a defined spectral domain or spectrum range, and the groups can be assigned with multiple spectral domains or spectral ranges. In one embodiment, CMs are grouped based on their distance to the CMTS or Fiber node, and the high spectral band is assigned to the near CM group and low spectral band to far CM group to balance the RF signal loss in a cable link or cable plant. To support 3 GHz expansion, a duplexer TAP can be used to replace the traditional tap and pass the high spectral band to the corresponding drop branch without a 20-26 dB TAP loss, in various embodiments. As shown in FIG. 7, one embodiment of the duplexer tap includes two duplexers and connected to a traditional tap.

The present subject matter applies multiple spectral domains in a cable network. One aspect provides a method for cable network communications including multiple CMs and a CMTS. The method includes designating the multiple CMs into groups based on distance from the CMTS. At least one of the groups is assigned a spectrum range for communications, wherein the assigned spectrum range is highest for groups closest to the CMTS and lowest for groups farthest from the CMTS. In various embodiments, assigning the spectrum range includes connecting a tap configured to separate the spectrum range between the CMs and the CMTS. The cable network communications include 3 GHz spectrum communications, in an embodiment. In various embodiments, the cable network communications include a DOCSIS® specification communication. In various embodiments, the method includes using a tap nearest the CMTS with a 3 GHz tap. At least one duplexer tap configured to reduce signal power branch loss is used, in various embodiments.

Another aspect provides a method for cable network communications including multiple CMs and a CMTS. The includes assigning a high spectrum range of communications to a first group of the multiple CMs closest to the CMTS, assigning a low spectrum range of communications to a third group of the multiple CMs furthest from the CMTS, and assigning at least one middle spectrum range of communications to at least one second group of the multiple CMs that are between the first group and the third group, wherein assigning the high, middle and low spectrum ranges includes connecting a tap configured to separate the spectrum range between the CMs and the CMTS, wherein grouped CMs can be assigned with a same spectrum range from any tap point. In one embodiment, the method includes replacing a tap nearest the CMTS with a 3 GHz tap. In various embodiments, the method includes using at least one duplexer tap configured to reduce signal power branch loss.

Another aspect provides a system for cable network communications. The system includes a CMTS, multiple CMs, and a plurality of taps used to connect the multiple CMs to the CMTS. In various embodiments, the taps are configured to provide a higher spectrum range of communications for CMs closest to the CMTS and a lower spectrum range of communications for CMs farthest from the CMTS. One or more of the plurality of taps includes a 3 GHz tap, in an embodiment. In various embodiments, one or more of the plurality of taps includes a duplexer tap. The duplexer tap includes multiple duplexers, in various embodiments. In one embodiment, the duplexer tap includes two duplexers. The duplexer tap is configured to reduce signal loss compared to a tap without duplexers, in various embodiments.

Another aspect provides a computer implemented system including processing circuitry, a storage device coupled to the processing circuitry, and code stored on the storage device for execution by the processing circuitry to perform operations. In various embodiments, the operations include designating CMs into groups based on distance from a CMTS, assigning at least one of the groups a spectrum range for communications, wherein the assigned spectrum range is higher for groups closest to the CMTS and lowest for groups farthest from the CMTS, and processing cable network communications using the processor. Various embodiments include replacing a tap nearest the CMTS with a 3 GHz tap. At least one duplexer tap configured to reduce signal power branch loss is used in various embodiments.

Another aspect provides a device including a processor, a communication module configured to couple to a network, and a storage device coupled to the processor to cause the processor to execute operations. In various embodiment the operations include designating CMs into groups based on distance from a CMTS, assigning at least one of the groups a spectrum range for communications, wherein the assigned spectrum range is higher for groups closest to the CMTS and lowest for groups farthest from the CMTS, and processing cable network communications using the processor. In various embodiments, the cable network communications include 3 GHz spectrum communications. The cable network communications include a DOCSIS® specification communication, in various embodiments.

### Tap for Spectrum Extension in a Cable Network

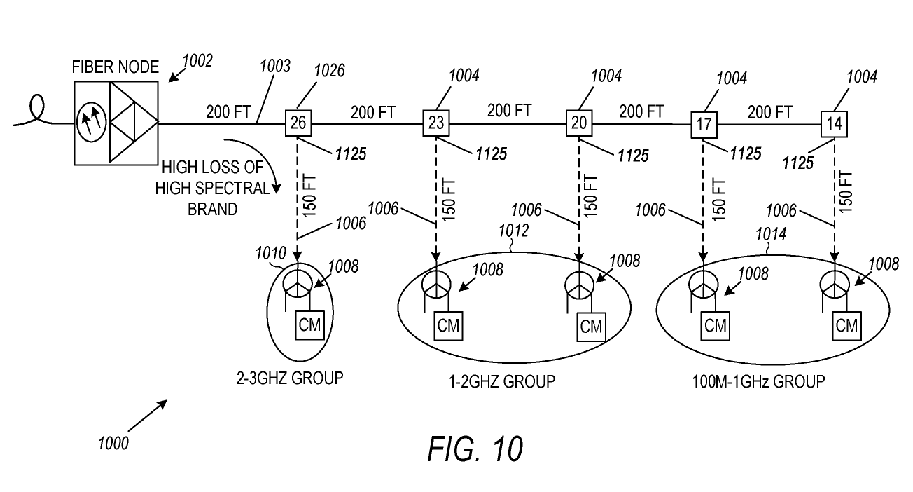

As described above and shown in FIG. 10, a new 3 GHz extension system architecture includes grouping CMs 1008 based on their distance to the CMTS 1002, and assigning the high spectral band to the near CM group 1010 using tap 1026 and low spectral band to far CM group 1014 to balance the signal loss. In various embodiments, a middle spectrum band is assigned to CMs in the mid-distance 1012.

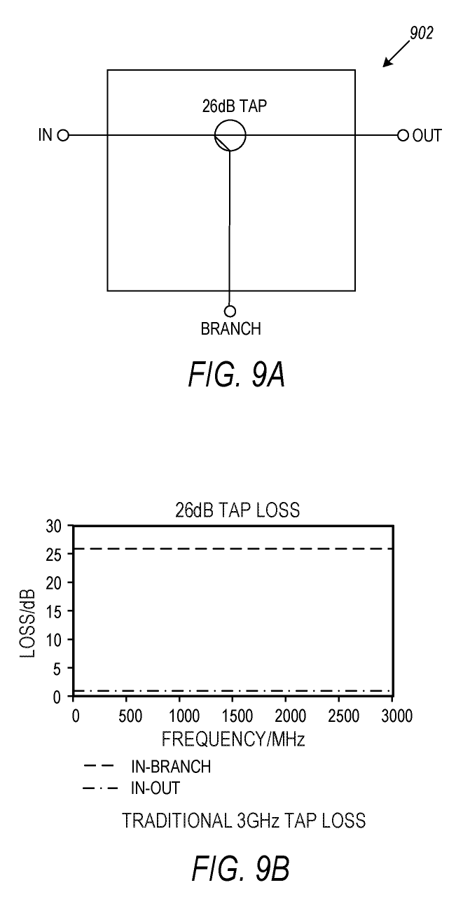

In a traditional 3 GHz tap as shown in FIG. 9A, the branch loss is almost the same in the working frequency range. For example, in FIG. 9B, for the tap 902 shown in FIG. 9A, the branch loss is 26 dB at for all frequencies from 5 MHz˜3 GHz. But for the high spectral band 2˜3 GHz which is assigned to the near CM 1010, the high branch loss equates to a loss of signal power.

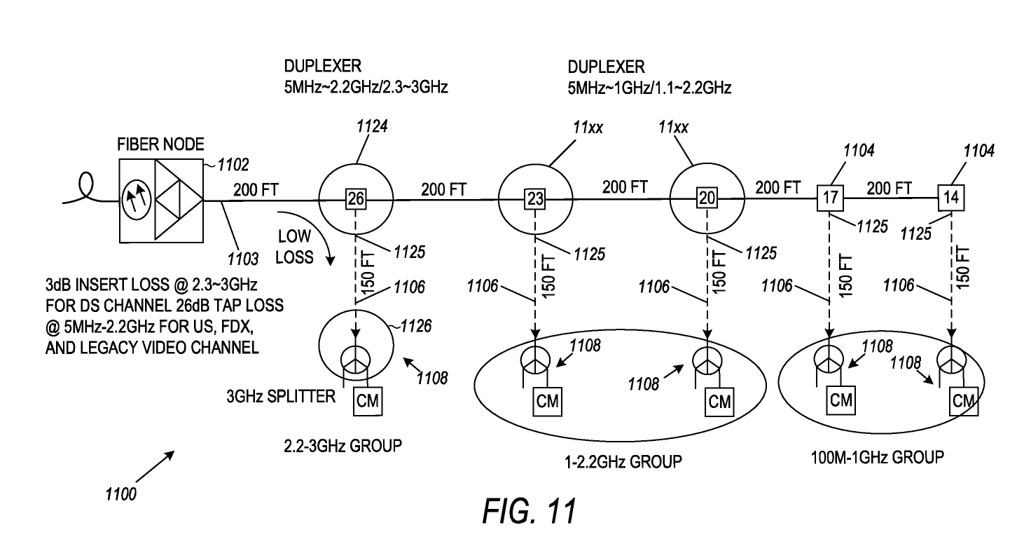

In the present subject matter, the tap 902 is replaced with a duplexer tap which passes the high spectral band signal to each drop, which reduces the tap loss in the high frequency band since there will be no signal power branch loss and only 1-3 dB duplexer insert loss. FIG. 11 is a circuit diagram illustrating a cable communications network with a replacement duplexer tap, according to various embodiments. In various embodiments, the trunk tap (or tap nearest the CMTS 1102) is replaced with a duplexer tap 1124 which passes the high spectral band signal to the CMs 1126.

In order to support current upstream communications, video and full duplex communications (FDX) channels, which are usually located at 5 MHz˜1.2 GHz in the 3 GHz CM group, the tap branches the low band signal with a 26 dB TAP to a 3 GHz drop cable, in various embodiments.

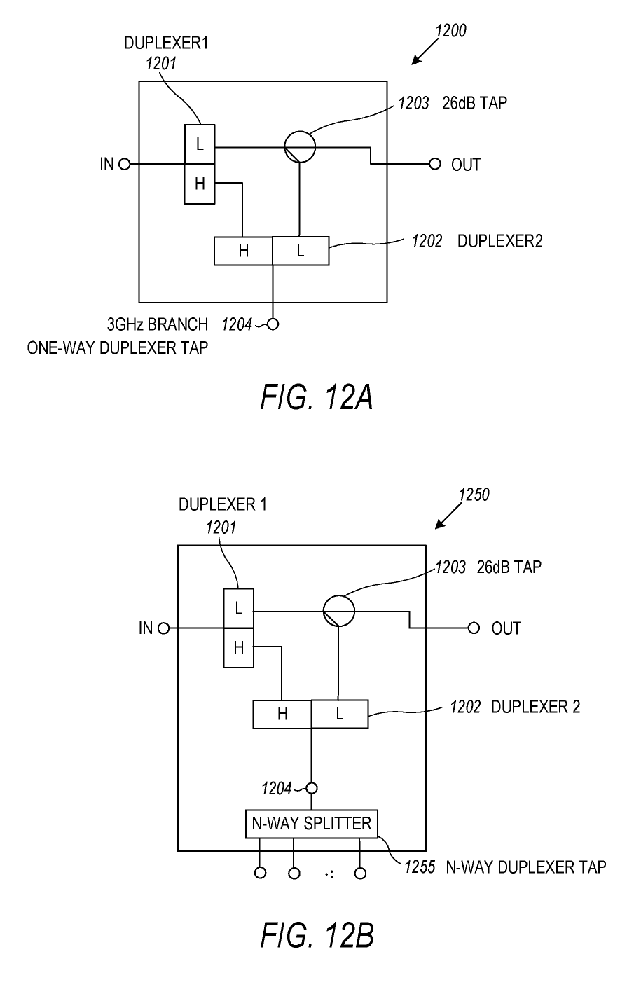

A duplexer tap 1200 is shown in FIG. 12A, including a first duplexer 1201 to split the 2.3˜3 GHz spectrum and pass it directly to a second duplexer 1202. Both the first and second duplexers are connected to a tap 1203. The second duplexer 1202 combines the 2.3-3 GHz signal and 5-2.2 GHz signal with an approximately 26 dB tap loss, in various embodiments. This provides the high spectral band to fully pass to the branch 1204.

FIG. 12B illustrates an N-way duplexer tap 1250 with two duplexers for use in a cable communications network, according to various embodiments. By cascading N-way splitter 1255 at the 3 GHz Branch port 1204, the one-way duplexer tap becomes an N-way duplexer tap

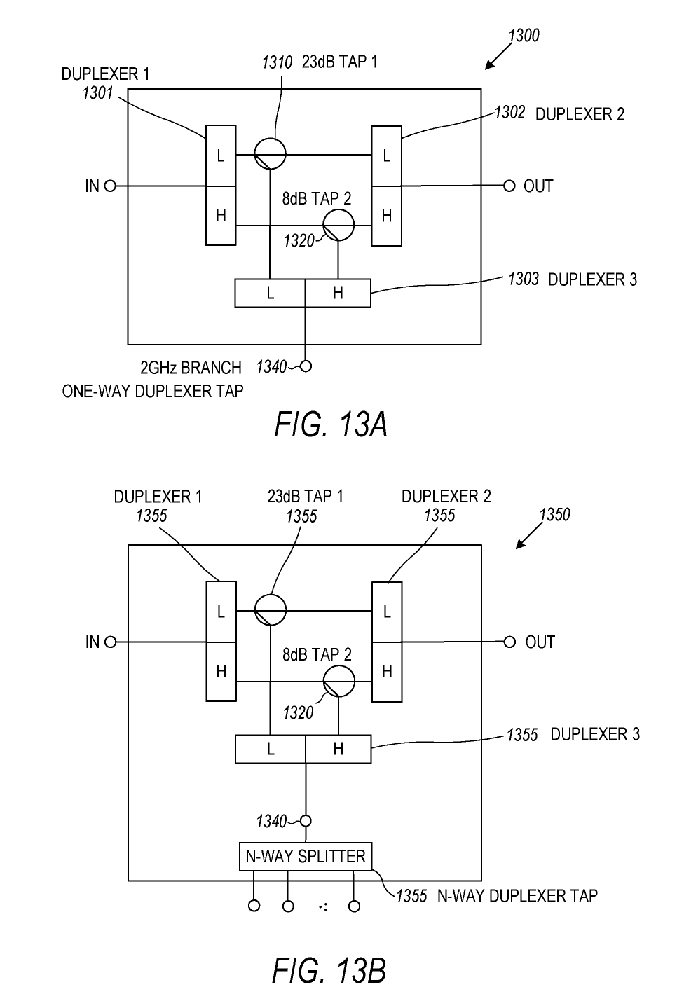

Another duplexer tap 1300 design is shown in FIG. 13A, including a first duplexer 1301 to split the 5 MHz˜1 GHz and split the 1.1˜2.2 GHz and pass these spectra to 23 dB tap 1310 and 8 dB tap 1320. The second duplexer 1302 combines the two signals coming from the output of the two taps 1310 and 1320. The third duplexer 1303 combines the two signals coming from the branch of the two taps 1310 and 1320, such that the high spectral band will partly pass to the branch 1340, and can pass to the output of next tap, in various embodiments.

FIG. 13B illustrates an N-way duplexer tap 1350 with two duplexers for use in a cable communications network, according to various embodiments. By including a cascading N-way splitter 1355 at the 2 GHz Branch port 1340, the one-way duplexer tap will become an N-way duplexer tap. As shown in FIG. 9B, the currently used tap has almost the same loss at the working frequency band, thus it is not suitable for the new 3 GHz extension system architecture.

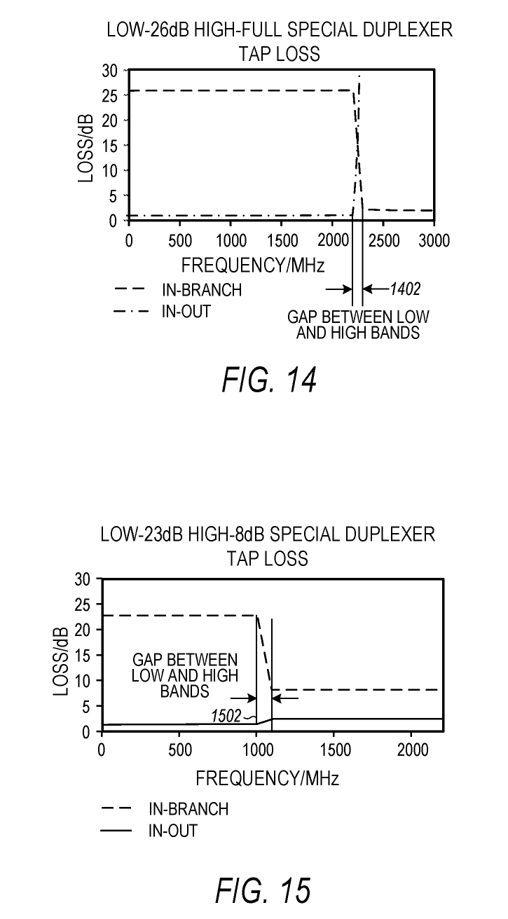

FIG. 14 is a graph illustrating signal power loss for the duplexer tap of FIG. 12A, according to various embodiments. The crossover frequency band, or gap 1402, is shown between low and high bands. In various embodiments, a switch is added to select the passband of the low spectral and high spectral frequencies of the first duplexer 1201 and the second duplexer 1202. In addition, a second switch can be added to select the branch loss of the tap 1203, according to various embodiments. These switches can be mechanical switches or software operable switches, in various embodiments. An equalizer can be used to fill the gap 1402 between the low and high bands, in various embodiments.

FIG. 15 is a graph illustrating signal power loss for the duplexer tap of FIG. 13A, according to various embodiments. The crossover frequency band, or gap 1502, is shown between low and high bands. In various embodiments, a switch is added to select the passband of the low spectral and high spectral frequencies of the first duplexer 1301, the second duplexer 1302, and the third duplexer 1303. In addition, a second switch can be added to select the branch loss of the taps 1310 and 1320, according to various embodiments. These switches can be mechanical switches or software operable switches, in various embodiments. An equalizer can be used to fill the gap 1502 between the low and high bands, in various embodiments.

The present subject matter provides a novel duplexer tap configured pass the low and high spectral bands to the corresponding drop branches with different tap losses. One embodiment includes a low-part high-full special duplexer design which includes two duplexers and a traditional tap. In another embodiment, a low-part high-part special duplexer design includes three duplexers and two traditional taps. By cascading an N-way splitter at the branch port, the one-way duplexer tap becomes an N-way duplexer tap, according to various embodiments.

Methods, apparatus, and systems are provided including a tap to support 3 GHz spectrum extension in a DOCSIS® cable network. One aspect provides a system for cable network communications. The system includes a CMTS, multiple CMs, and a plurality of taps used to connect the multiple CMs to the CMTS. According to various embodiments at least one of the taps includes a duplexer tap configured to provide a selected spectrum range of communications from the CMTS to one or more of the CMs. One or more of the plurality of taps includes a 3 GHz tap, in an embodiment. In various embodiments, the duplexer tap includes multiple duplexers. The duplexer tap includes a cascading n-way splitter, in an embodiment. The duplexer tap is configured to reduce signal loss compared to a tap without duplexers. In one embodiment, the duplexer tap is configured with an approximate 3 dB loss at a spectrum of approximately 2.3 to 3 GHz. The duplexer tap is configured with an approximate 26 dB loss at a spectrum of approximately 5 MHz to 2.2 GHz, in an embodiment. In various embodiments, the duplexer tap is configured with a first duplexer configured to split a signal into a first spectrum range with a first signal loss and a second spectrum range with a second signal loss, wherein the first signal loss is not equal to the second signal loss.

Another aspect provides a method for cable network communications including multiple cable modems (CMs) and a cable modem termination system (CMTS). The method includes using a duplexer tap to connect one or more of the multiple CMs to the CMTS. According to various embodiments, a selected spectrum range of communications is provided from the CMTS to the one or more of the CMs using the duplexer tap. In various embodiments, the method further includes designating the multiple CMs into groups based on distance from the CMTS, and the selected spectrum range is highest for CMs closest to the CMTS and lowest for CMs farthest from the CMTS. The duplexer tap includes a 3 GHz tap, in an embodiment. In various embodiments, the duplexer tap includes multiple duplexers. The duplexer tap includes a cascading n-way splitter, in an embodiment. The duplexer tap is configured to reduce signal loss compared to a tap without duplexers. In one embodiment, the duplexer tap is configured to provide multiple spectral ranges with different tap losses for each of the multiple spectral ranges.

A further aspect provides a method for cable network communications including multiple CMs and a CMTS. The method includes using a duplexer tap to provide a first spectrum range of communications to a first group of the multiple CMs from to the CMTS, and using the duplexer tap to provide a second spectrum range of communications to a second group of the multiple CMs from the CMTS, in various embodiments. In one embodiment, the duplexer tap is configured with an approximate 3 dB loss at a spectrum of approximately 2.3 to 3 GHz. The duplexer tap is configured with an approximate 26 dB loss at a spectrum of approximately 5 MHz to 2.2 GHz, in an embodiment. In various embodiments, the duplexer tap is configured with a first duplexer that is configured to split a signal into a first spectrum range with a first signal loss and a second spectrum range with a second signal loss, wherein the first signal loss is not equal to the second signal loss. The duplexer tap includes cascading n-way splitters at a branch port, in various embodiments.

### Example Hardware Embodiments

FIG. 8 is a schematic diagram illustrating circuitry for performing methods according to example embodiments. All components need not be used in various embodiments. For example, the computing devices may each use a different set of components and storage devices.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, or other computing device including the same or similar elements as illustrated and described with regard to FIG. 8. Devices such as smartphones, tablets, and smartwatches are generally collectively referred to as mobile devices. Further, although the various data storage elements are illustrated as part of the computer 800, the storage may also or alternatively include cloud-based storage accessible via a network, such as the Internet or server based storage.

Memory 803 may include volatile memory 814 and/or non-volatile memory 808. Computer 800 may include—or have access to a computing environment that includes—a variety of computer-readable media, such as volatile memory 814 and/or non-volatile memory 808, removable storage 810 and/or non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input device 806, output device 804, and a communication interface 816. In various embodiments, communication interface 816 includes a transceiver and an antenna. Output device 804 may include a display device, such as a touchscreen, that also may serve as an input device. The input device 806 may include one or more of a touchscreen, touchpad, mouse, keyboard, camera, one or more device-specific buttons, one or more sensors 807 integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions, i.e., a program 818, comprises instructions stored on a computer-readable medium that are executable by the processing unit 802 of the computer 800. A hard drive, CD-ROM, or RAM are some examples of articles including a non-transitory computer-readable medium, such as a storage device. The terms computer-readable medium and storage device do not include carrier waves to the extent carrier waves are deemed too transitory. Storage can also include networked storage such as a storage area network (SAN).

In some embodiments, the computer 800 executes the program 818 to designate cable modems (CMs) into groups based on distance from a cable modem termination system (CMTS), assign at least one of the groups a spectrum range for communications, wherein the assigned spectrum range is higher for groups closest to the CMTS and lowest for groups farthest from the CMTS, and process cable network communications using the processor. In some embodiments, the computer 800 executes the program 818 to use a duplexer tap to provide a first spectrum range of communications to a first group of the multiple CMs from to the CMTS, and to provide a second spectrum range of communications to a second group of the multiple CMs from the CMTS.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate, preclude or suggest that a combination of these measures cannot be used to advantage. A computer program may be stored or distributed on a suitable medium, such as an optical storage medium or a solid-state medium supplied together with, or as part of, other hardware, but may also be distributed in other forms, such as via the Internet or other wired or wireless telecommunication systems.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A system for cable network communications, the system comprising:
a cable modem termination system (CMTS);
a trunk cable coupled to the CMTS;
a plurality of cable modems (CMs) divided into at least a low frequency CM group and a high frequency CM group, with the high frequency CM group positioned between the CMTS and the low frequency CM group;
one or more second taps attached to the trunk cable, with corresponding second drop cables coupled to the one or more second taps and further coupled to one or more corresponding CMs of the low frequency CM group; and
a first duplexer tap attached to the trunk cable between the CMTS and the one or more second taps, with a corresponding first drop cable coupled to the first duplexer tap and further coupled to a CM of the high frequency CM group, with the first duplexer tap receiving an input signal from the CMTS and providing a low frequency signal of the input signal to the low frequency CM group and providing a high frequency signal of the input signal to the high frequency CM group.

2. The system of claim 1, wherein the high frequency signal comprises an about 2.2 Gigahertz (GHz) to about 3 GHz frequency band and the low frequency signal comprises an about 1 Megahertz (MHz) to about 2.2 GHz frequency band.

3. The system of claim 1, wherein the high frequency signal comprises an about 2.0 GHz to about 3 GHz frequency band and the low frequency signal comprises an about 1 Megahertz (MHz) to about 2 GHz frequency band.

4. The system of claim 1, further comprising one or more second duplexer taps attached to the trunk cable between the first duplexer tap and the one or more second taps and forming a medium frequency CM group, with corresponding second duplexer drop cables coupled to the one or more second duplexer taps and further coupled to one or more corresponding medium frequency CMs of the medium frequency CM group.

5. The system of claim 4, wherein the high frequency signal comprises an about 2.2 Gigahertz (GHz) to about 3 GHz frequency band, the medium frequency signal comprises an about 1 Gigahertz (GHz) to about 2.2 GHz frequency band, and the low frequency signal comprises an about 100 Megahertz (MHz) to about 1 GHz frequency band.

6. The system of claim 4, wherein the high frequency signal comprises an about 2.0 GHz to about 3 GHz frequency band, the medium frequency signal comprises an about 1 Gigahertz (GHz) to about 2 GHz frequency band, and the low frequency signal comprises an about 1 Megahertz (MHz) to about 1 GHz frequency band.

7. The system of claim 1, wherein the duplexer tap comprises two duplexer components.

8. The system of claim 1, wherein the duplexer tap comprises:
a first duplexer receiving the input signal of the duplexer tap and providing a low frequency signal and a high frequency signal from the input signal;
a second duplexer receiving the high frequency signal from the first duplexer and receiving a branch signal from a tap and outputting the high frequency signal on a branch port of the duplexer tap; and
the tap receiving the low frequency signal from the first duplexer and outputting the low frequency signal on an output port of the duplexer tap.

9. The system of claim 8, with the tap further outputting the branch signal on a branch port of the tap.

10. The system of claim 1, wherein the duplexer tap comprises:
a first duplexer coupled to an input port of the duplexer tap and receiving the input signal from the input port, with the first duplexer providing a low frequency signal on a low frequency port of the first duplexer and providing a high frequency signal on a high frequency port of the first duplexer;
a second duplexer having a high frequency port coupled to the high frequency port of the first duplexer and having a low frequency port coupled to a tap, with the second duplexer combining a high frequency signal received from the first duplexer and a branch signal received from the tap and outputting the high frequency signal on a branch port and on a branch port of the duplexer tap; and
the tap coupled to the low frequency port of the first duplexer, coupled to the low frequency port of the second duplexer, and coupled to the output port of the duplexer tap, with the tap outputting the low frequency signal on the output port of the duplexer tap.

11. A method for cable network communications, the method comprising:
a tap receiving an input signal, with the tap located on a trunk cable of a cable network;
the tap dividing the input signal into at least a high frequency signal and a low frequency signal and providing the high frequency signal to a high frequency cable modem (CM) group, wherein the high frequency signal is transmitted over a drop cable from the tap to a CM of the high frequency CM group; and
the tap providing the low frequency signal to a low frequency CM group, wherein the low frequency signal is transmitted over one or more drop cables coupled to one or more corresponding CMs of the low frequency CM group and wherein the low frequency CM group is downstream of the high frequency CM group.

12. The method of claim 11, wherein the high frequency signal comprises an about 2.2 Gigahertz (GHz) to about 3 GHz frequency band and the low frequency signal comprises an about 1 Megahertz (MHz) to about 2.2 GHz frequency band.

13. The method of claim 11, wherein the high frequency signal comprises an about 2.0 GHz to about 3 GHz frequency band and the low frequency signal comprises an about 1 Megahertz (MHz) to about 2 GHz frequency band.

14. The method of claim 11, further comprising:
a downstream tap located on the trunk cable receiving the low frequency signal from the tap;
the downstream tap dividing the low frequency signal into a medium frequency signal and a lower frequency signal and providing the medium frequency signal to a medium frequency CM group; and
the downstream tap providing the lower frequency signal to the low frequency CM group.

15. The method of claim 14, wherein the high frequency signal comprises an about 2.2 Gigahertz (GHz) to about 3 GHz frequency band, the medium frequency signal comprises an about 1 Gigahertz (GHz) to about 2.2 GHz frequency band, and the low frequency signal comprises an about 100 Megahertz (MHz) to about 1 GHz frequency band.

16. The method of claim 14, wherein the high frequency signal comprises an about 2.0 GHz to about 3 GHz frequency band, the medium frequency signal comprises an about 1 Gigahertz (GHz) to about 2 GHz frequency band, and the low frequency signal comprises an about 1 Megahertz (MHz) to about 1 GHz frequency band.

17. The method of claim 11, further comprising:
receiving the input signal of the duplexer tap at a first duplexer and the first duplexer providing a low frequency signal and a high frequency signal from the input signal;
receiving the high frequency signal from the first duplexer at a second duplexer and the second duplexer receiving a branch signal from a tap and outputting the high frequency signal on a branch port of the duplexer tap; and
receiving the low frequency signal from the first duplexer at a tap and the tap outputting the low frequency signal on an output port of the duplexer tap.

18. The method of claim 17, further outputting the branch signal on a branch port of the tap.
